(19) United States
(12) Patent Application Publication
(10) Pub. No.: US 2010/0021214 A1
(43) Pub. Date: Jan. 28, 2010

(54) DEVELOPING DEVICE, IMAGE FORMING APPARATUS, AND PROCESS CARTRIDGE

(76) Inventors: Ichiro KADOTA, Kanagawa (JP); Yasuyuki ISHII, Tokyo (JP); Tomoko TAKAHASHI, Kanagawa (JP); Masaaki YAMADA, Tokyo (JP); Hideki KOSUGI, Kanagawa (JP); Yoshinori NAKAGAWA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/475,931

(22) Filed: Jun. 1, 2009

(30) Foreign Application Priority Data
Jul. 22, 2008 (JP) 2008-189118

(51) Int. Cl. G03G 15/08

(52) U.S. Cl. 399/266

(57) ABSTRACT

A toner carrying member includes a plurality of electrodes arranged in a first direction intersecting with a second direction in which its surface moves. A voltage applying unit applies a bias to the electrodes such that an electric field direction is changed temporally in an alternate manner between adjacent electrodes. An adjusting member adjusts an amount of toner carried on the toner carrying member. A toner-cloud facilitating member includes a conductive member arranged between the toner supplying member and the adjusting member in the second direction in opposite to the toner carrying member.

### CROSS-REFERENCE TO RELATED APPLICATIONS

The present application claims priority to and incorporates by reference the entire contents of Japanese priority document 2008-189118 filed in Japan on Jul. 22, 2008.

### BACKGROUND OF THE INVENTION

1. Field of the Invention

The present invention relates to a developing device, and an image forming apparatus including the developing device.

2. Description of the Related Art

A conventional developing device used in an image forming apparatus, such as a copier, a printer, or a facsimile, employs a two-component developing system or a one-component developing system. The two-component developing system is highly suitable for a high-speed developing operation, and nowadays a medium-speed or high-speed image forming apparatus mainly employs the two-component developing system. To achieve high image quality in the two-component developing system, it is necessary to obtain a highly dense state of developer at an area where the developer is brought into contact with an electrostatic latent image formed on a surface of a latent-image carrying member. For that purpose, a diameter of a carrier particle has been reduced, and a carrier particle having a diameter of about 30 μm has been employed for commercial use.

Because the one-component developing system allows reduction in its size and weight, nowadays a low-speed image forming apparatus mainly employs the one-component developing system. In the one-component developing system, a toner adjusting member such as a blade or a roller is in contact with toner adhering to a developing roller to form a toner thin layer on a surface of the developing roller, and thus the toner is charged due to friction between the toner and the developing roller or the toner adjusting member. A charged toner thin layer formed on the developing roller is conveyed to a development area whereby an electrostatic latent image formed on a surface of a latent-image carrying member is developed with the toner. A system for developing the electrostatic latent image with the toner is roughly divided into two types, i.e., contact type in which the developing roller is brought into contact with the latent-image carrying member and non-contact type in which the developing roller is not brought into contact with the latent-image carrying member.

Japanese Patent Application Laid-open No. H03-100575 discloses a hybrid system in which the two-component developing system and the one-component developing system are combined to compensate disadvantages of both of them.

Japanese Patent Application Laid-open No. H03-113474 discloses a method of developing fine uniform dots with high resolution in which a wire to which high-frequency bias is applied is arranged at a development area whereby toner cloud is generated at the development area, so that the dots with high resolution can be developed in an improved manner.

Japanese Patent Application Laid-open No. H03-21967 discloses a method of forming an electric field curtain on a roller thereby effectively forming toner cloud in a stable manner.

Japanese Patent Application Laid-open No. 2003-15419 discloses a developing device in which developer is conveyed by an electric field curtain due to a traveling-wave electric field. Japanese Patent Application Laid-open No. H09-269661 discloses a developing device including a plurality of magnetic poles that causes substantially one layer of carrier to adhere to a circumference of a developing roller almost evenly. Japanese Patent Application Laid-open No. 2003-84560 discloses a developing device in which a conductive electrode pattern is arranged at intervals via an insulating member on a surface of a developer carrying member that carries nonmagnetic toner, and a predetermined bias potential is applied to electrodes to generate electric field gradient, so that the nonmagnetic toner is caused to adhere to the developer carrying member and conveyed by the developer carrying member.

Because a dot size for a required pixel needs to be equivalent to or smaller than a diameter of a carrier particle because of increasing requirement for high image quality in the two-component developing system, it is necessary to make the diameter of the carrier particle smaller in order to improve reproducibility of an isolated dot. However, if the diameter of the carrier particle is made smaller, magnetic permeability of the carrier particle is reduced, which causes the carrier particle to be easily removed from a developing roller. If the removed carrier particle adheres to a latent-image carrying member, various adverse effects can occur, for example, an image defect can occur due to adherence of the carrier particle, or the latent-image carrying member can get damaged by the carrier particle.

To prevent the carrier particle from being removed from the developing roller, there have been attempts to increase the magnetic permeability of the carrier particle in terms of materials and to increase magnetic force of a magnet included in the developing roller. However, such development has been difficult because of a balance between low costs and high image quality. Furthermore, because the diameter of the developing roller has been increasingly reduced in accordance with the size reduction of the developing device, it is difficult to design a developing roller having a configuration to generate a strong magnetic field such that the carrier particle is completely prevented from being removed from the developing roller.

Because the two-component developing system performs a process of forming a toner image by sliding particles of a two-component developer called a magnetic brush on an electrostatic latent image, an isolated dot can be developed unevenly due to ununiformity of the particles. Although image quality can be improved by generating an alternating electric field between the developing roller and the latent-image carrying member, it is difficult to eliminate a fundamental problem such as unevenness of an image caused by the ununiformity of the developer particles.

In the one-component developing system, because a toner layer formed on the developing roller by the toner adjusting member is completely pressed against the developing roller, responsiveness of the toner to the electric field at the developing area is extremely low. Therefore, although a strong alternating electric field is generally formed between the developing roller and the latent-image carrying member to achieve high image quality, the formation of the alternating electric field does not make it easy to apply a certain amount of toner to an electrostatic latent image in a stable manner, and therefore it is difficult to develop fine dots with high resolution in a uniform manner. Moreover, because the one-component developing system causes high stress on toner when a toner thin layer is formed on the developing roller, the toner circulating through the developing device gets easily damaged. Unevenness can easily occur at a process of forming the toner thin layer on the developing roller because of the damaged toner, and therefore the one-component developing system is not generally suitable for a high-speed or highly-durable image forming apparatus.

Although the size of the developing device employing the hybrid system is large and the number of components included in the developing device is increased, some of the problems can be solved by the hybrid system. However, the hybrid system has the same problem at the development area as the one-component developing system, that is, it is difficult to develop fine uniform dots with high resolution.

Although it is considered that the method disclosed in Japanese Patent Application Laid-open No. H03-113474 can achieve development with high stability and high image quality, the configuration of the developing device is complicated.

Although it is understood that the method disclosed in Japanese Patent Application Laid-open No. H03-21967 is superior in achieving size reduction and development with high image quality, it has been found out as a result of intensive researches conducted by the inventor(s) that it is necessary to limit conditions of the electric field curtain to be formed and a developing operation to achieve the high image quality. That is, if an image forming process is performed under an improper condition, not only the high image quality cannot be obtained at all, but also low image quality can be provided.

In an image forming process in which a first toner image, a second toner image, and a third toner image are sequentially formed on a latent-image carrying member, a developing system needs to perform a developing operation without damaging the toner image previously formed on the latent-image carrying member. Although it is possible that the toner images of different colors are sequentially formed on the latent-image carrying member by using a non-contact one-component developing system or the toner-cloud developing system disclosed in Japanese Patent Application Laid-open No. H03-113474, because an alternating electric field is generated between the latent-image carrying member and the developing roller in the above systems, a part of toner is removed from the toner image previously formed on the latent-image carrying member due to the alternating electric field and the removed toner enters the developing device. As a result, not only the image formed on the latent-image carrying member is damaged, but also the toner contained in the developing device is mixed with toner of a different color. Theses problems make it difficult to obtain the high image quality, and it is necessary to develop an image without forming the alternating electric field between the latent-image carrying member and the developing roller to solve the above problems.

Although it is considered that such a developing operation can be effectively performed by using the cloud developing system disclosed in Japanese Patent Application Laid-open No. H03-21967, as described above, the high image quality cannot be obtained unless an image forming process is performed under a proper condition.

Japanese Patent Application Laid-open No. 2002-341656 discloses a method of developing an image with toner that is electrostatically conveyed by an alternating electric field having more than three phases without mechanically driving a toner carrying member. However, if the toner cannot be electrostatically conveyed for some reason, the toner is accumulated on a conveying board, resulting in a functional failure. Although Japanese Patent Application Laid-open No. 2004-286837 discloses a configuration in which a fixed conveying member and a toner carrying member that is moved on a surface of the fixed conveying member are used in combination to solve the above problem, its mechanism is complicated.

Japanese Patent Application Laid-open No. 2008-008929 discloses a flare system in which a periodically changed electric field is generated between electrodes having two phases whereby the toner is caused to hop on a toner carrying member, and the toner carrying member is rotated to convey the toner to an area where the toner carrying member is opposed to a latent-image carrying member, so that a latent image formed on the latent-image carrying member is developed with the toner.

In a system employing, instead of a conventional one-component developing roller, a toner carrying member (hereinafter, “flare roller”) including groups of fine-pitch electrodes having two phases thereby causing the toner to hop on a surface of the flare roller, a hopping state of the toner is closely related to an amount of developer. Specifically, if the toner adheres to the flare roller without hopping, an amount of the toner to be transferred onto a latent-image carrying member is decreased, resulting in insufficient image density. Therefore, it is necessary to obtain a proper hopping state of the toner while the toner is conveyed from a supply area to a development area.

### SUMMARY OF THE INVENTION

It is an object of the present invention to at least partially solve the problems in the conventional technology.

According to one aspect of the present invention, there is provided a developing device including a toner carrying member that includes a plurality of electrodes arranged at predetermined intervals in a first direction intersecting with a second direction in which a surface of the toner carrying member moves, a toner supplying member that supplies toner to the toner carrying member, a voltage applying unit that applies a bias to the electrodes in a time-varying manner such that a direction of an electric field is changed temporally in an alternate manner between adjacent electrodes so that the toner carried on the toner carrying member is caused to hop to form a toner cloud, an adjusting member that adjusts an amount of the toner carried on the toner carrying member. The developing device further includes a toner-cloud facilitating member that includes a conductive member arranged between the toner supplying member and the adjusting member in the second direction in opposite to the toner carrying member.

Furthermore, according to another aspect of the present invention, there is provided a process cartridge used in an electrophotographic system. The process cartridge includes a developing unit and at least one of a latent image carrier, a charging unit, and a cleaning unit in an integrated manner. The developing unit includes a toner carrying member that includes a plurality of electrodes arranged at predetermined intervals in a first direction intersecting with a second direction in which a surface of the toner carrying member moves, a toner supplying member that supplies toner to the toner carrying member, a voltage applying unit that applies a bias to the electrodes in a time-varying manner such that a direction of an electric field is changed temporally in an alternate manner between adjacent electrodes so that the toner carried on the toner carrying member is caused to hop to form a toner cloud, an adjusting member that adjusts an amount of the toner carried on the toner carrying member, and a toner-cloud facilitating member that includes a conductive member arranged between the toner supplying member and the adjusting member in the second direction in opposite to the toner carrying member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a developing device employing the flare system according to a first embodiment of the present invention;

FIG. 2 is a schematic diagram of a relevant part of an image forming apparatus including the developing device;

FIGS. 3A and 3B are schematic diagrams for explaining arrangement of electrodes included in a flare roller shown in FIG. 1;

FIG. 4 is a cross-sectional view of the electrodes in a circumferential direction of the flare roller;

FIG. 5 is a planar development view of the electrodes;

FIGS. 6A and 6B are waveform diagrams of drive voltages applied to the electrodes;

FIG. 7 is a graph for explaining difference in effects with and without a toner-cloud facilitating member shown in FIG. 1; and

FIG. 8 is a schematic diagram of a developing device including a wire electrode as a toner-cloud facilitating member according to modification.

### DETAILED DESCRIPTION OF THE PREFERRED EMBODIMENTS

Exemplary embodiments of the present invention are explained in detail below with reference to the accompanying drawings.

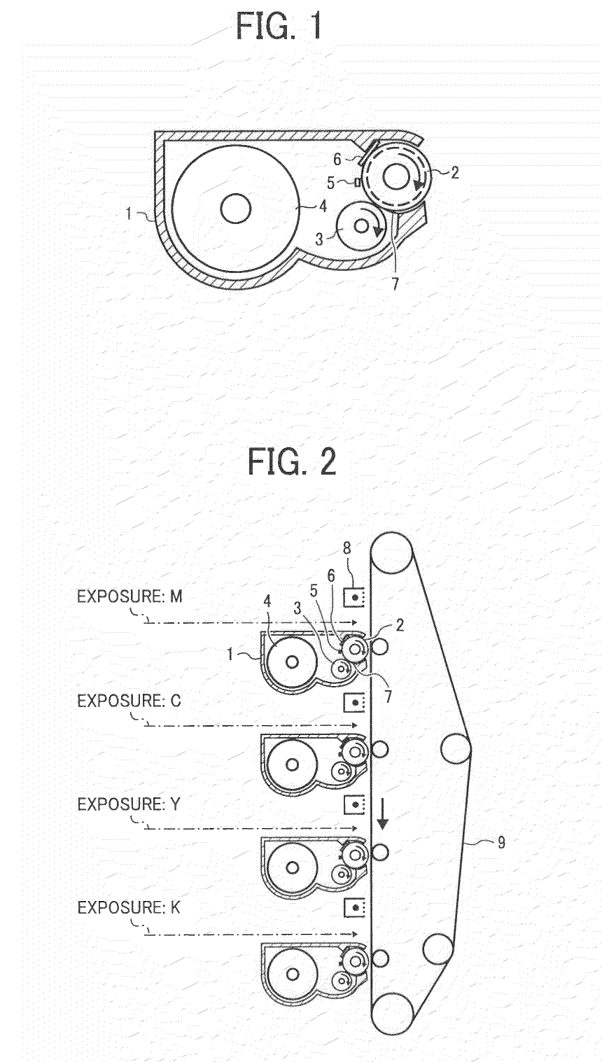

FIG. 1 is a schematic diagram of a developing device 1 employing the flare system according to a first embodiment of the present invention. The developing device 1 includes a flare roller 2, a supplying and removing roller 3, a stirring paddle 4, a toner-cloud facilitating member 5, a layer-thickness adjusting member 6, and a toner-leakage preventing member 7.

FIG. 2 is a schematic diagram of a relevant part of an image forming apparatus including the developing device 1. The image forming apparatus further includes a charging device 8 and a belt-like image carrier 9 serving as a photosensitive element. Four colors, i.e., cyan, magenta, yellow, and black, are indicated with reference marks C, M, Y, and K.

The image forming apparatus forms toner images corresponding to the four colors on a surface of the image carrier 9 in a superimposed manner. The flare system will be described in detail later. The image carrier 9 is supported by a plurality of rollers and is rotated by a drive unit (not shown). The developing devices 1 serving as image forming units that form images corresponding to the four colors are opposed to the image carrier 9. First, the image carrier 9 is uniformly charged by the charging device 8 corresponding to magenta and irradiated with a light beam that is modulated based on image data corresponding to magenta and emitted from a writing device (not shown) serving as an exposure unit whereby an electrostatic latent image is formed on the surface of the image carrier 9. The electrostatic latent image is then developed by the developing device 1 corresponding to magenta, so that a magenta toner image is formed on the surface of the image carrier 9. Afterward, the image carrier 9 is neutralized by a neutralizing device (not shown), and stands by for a subsequent image forming process of a different color.

The image carrier 9 is then uniformly charged by the charging device 8 corresponding to cyan and irradiated with a light beam that is modulated based on image data corresponding to cyan and emitted from a writing device (not shown) serving as an exposure unit whereby an electrostatic latent image is formed on the surface of the image carrier 9. The electrostatic latent image is then developed by the developing device 1 corresponding to cyan, so that a cyan toner image is formed on the surface of the image carrier 9 such that the cyan toner image is superimposed on the magenta toner image. Afterward, the image carrier 9 is neutralized by a neutralizing device (not shown), and stands by for a subsequent image forming process of a different color.

The image carrier 9 is then uniformly charged by the charging device 8 corresponding to yellow and irradiated with a light beam that is modulated based on image data corresponding to yellow and emitted from a writing device (not shown) serving as an exposure unit whereby an electrostatic latent image is formed on the surface of the image carrier 9. The electrostatic latent image is then developed by the developing device 1 corresponding to yellow, so that a yellow toner image is formed on the surface of the image carrier 9 such that the yellow toner image is superimposed on the magenta toner image and the cyan toner image. Afterward, the image carrier 9 is neutralized by a neutralizing device (not shown), and stands by for a subsequent image forming process of a different color.

Finally, the image carrier 9 is uniformly charged by the charging device 8 corresponding to black and irradiated with a light beam that is modulated based on image data corresponding to black and emitted from a writing device (not shown) serving as an exposure unit whereby an electrostatic latent image is formed on the surface of the image carrier 9. The electrostatic latent image is then developed by the developing device 1 corresponding to black, so that a black toner image is formed on the surface of the image carrier 9 such that the black toner image is superimposed on the magenta toner image, the cyan toner image, and the yellow toner image. Thus, a full-color image is formed on the surface of the image carrier 9.

A recording medium such as a recording sheet is fed from a feed device (not shown). The full-color image formed on the surface of the image carrier 9 is transferred onto the recording medium by a transfer roller serving as a transfer unit to which transfer bias is applied from a power source (not shown). The full-color image is fixed to the recording medium by a fixing device (not shown), and the recording medium is then discharged out of the image forming apparatus. After the full-color image is transferred onto the recording medium from the image carrier 9, a cleaner (not shown) serving as a cleaning unit cleans residual toner from the surface of the image carrier 9.

As described above, because the image forming apparatus performs the writing operations corresponding to the four colors on the common photosensitive element, the images can be formed with less misalignment in principle, compared with a generally used four-drum tandem system. Thus, it is possible to form the images on the surface of the common photosensitive element in a superimposed manner without misalignment thereby generating a full-color image with high image quality. In a system for forming images in a superimposed manner using the developing device 1, because a toner carrying member is not in contact with a photosensitive element and an alternating electric field is not generated at a development area, a developing process of a subsequent color does not affect a toner image previously formed on the surface of the photosensitive element mechanically or electrically. Therefore, a problem, such as scavenge or color mixture, does not occur, and an image forming process can be performed with high image quality in a stable manner for a long period.

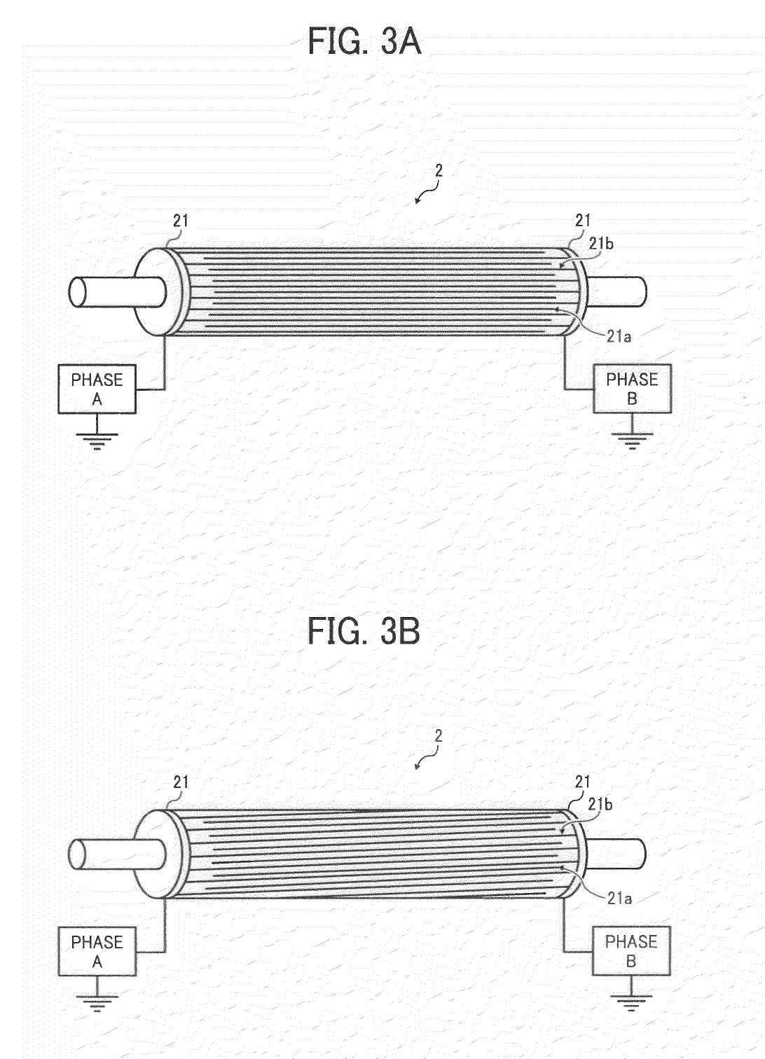

FIG. 3A is a schematic diagram for explaining a group of electrodes 21a corresponding to an phase A and a group of electrodes 21b corresponding to a phase B arranged on the flare roller 2 in a linear fashion, and FIG. 3B is a schematic diagram for explaining the electrodes 21a and 21b arranged on the flare roller 2 in a twisted fashion.

A power-source connecting section 21 is circumferentially arranged on both ends of the flare roller 2.

Although the electrodes 21a and 21b are arranged in parallel to one another in a linear fashion in an axial direction of the flare roller 2 as shown in FIG. 3A, the electrodes 21a and 21b can be arranged in a twisted fashion as shown in FIG. 3B. It is preferable that the electrodes 21a and 21b are arranged with a constant interval.

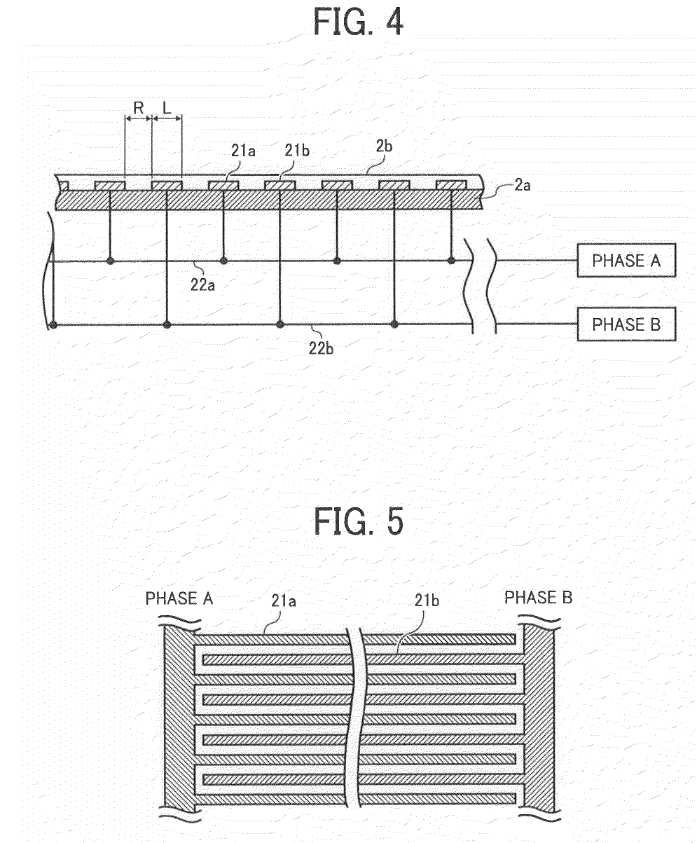

FIG. 4 is a cross-sectional view of the electrodes 21a and 21b in a circumferential direction of the flare roller 2. Cylindrical sections of the flare roller 2 are expanded in a linear fashion.

The flare roller 2 includes a support substrate 2a and a surface protecting layer 2b made of an inorganic or organic insulating material. A conductive wire 22a corresponding to the phase A is connected to the electrodes 21a, and a conductive wire 22b corresponding to the phase B is connected to the electrodes 21b. The electrodes 21a and 21b are arranged with an interval R. Each of the electrodes 21a and 21b has a width L.

The electrodes 21a and 21b are arranged on the support substrate 2a with the interval R, and the surface protecting layer 2b is formed on the support substrate 2a and the electrodes 21a and 21b. The conductive wires 22a and 22b are used to apply voltages to the electrodes 21a and 21b. Crossed parts of the conductive wires 22a and 22b indicated with black circles are electrically connected, and the other crossed parts are electrically insulated. Different drive voltages having two phases, i.e., the phase A and the phase B, are applied to the electrodes 21a and 21b from a power source (not shown) arranged in a main body of the image forming apparatus.

FIG. 5 is a planar development view of the electrodes 21a and 21b.

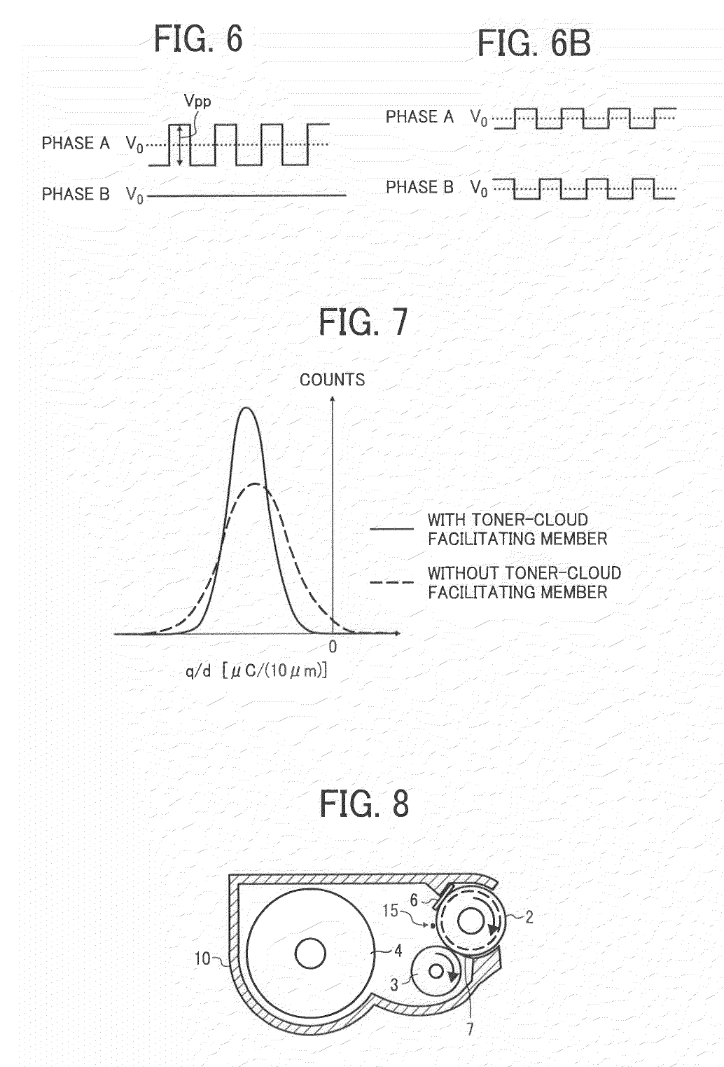

FIGS. 6A and 6B are waveform diagrams of the drive voltages applied to the electrodes 21a and 21b. As shown in FIG. 6A, the voltage having the phase B is fixed while the voltage having the phase A is relatively oscillated. As shown in FIG. 6B, the voltages are applied to the electrodes 21a and 21b such that the phase A and the phase B are reverse with respect to each other.

The electrodes 21a and 21b generate an electric field to cause the toner to hop. For example, the drive voltages having the different phases as shown in FIG. 6A or 6B are applied to the even-numbered electrodes and the odd-numbered electrodes from a drive circuit (not shown) whereby electric potential difference is periodically generated between the electrodes 21a and 21b. As a result, oppositely directed electric fields are alternately generated between the adjacent electrodes.

The odd-numbered electrodes are connected to one side of a rotary shaft of the rotating flare roller 2, and the even-numbered electrodes are connected to the other side of the rotary shaft.

The support substrate 2a can be made of an insulating material such as resin or can be a substrate made of a conducting material such as SUS on which an insulating film made of SiO₂, or the like, is formed.

The electrodes 21a and 21b are formed such that a film of a conducting material such as Al, Cu, or Ni—Cr is formed on the support substrate 2a in a thickness of 0.1 μm to 10 μm, preferably 0.5 μm to 2.0 μm, and then patterning is performed on the film by photolithography, or the like, to form a desired electrode pattern.

The width L and the interval R have a large influence on hopping efficiency of the toner. A pitch P between the electrodes 21a and 21b is obtained by an equation P=R+L.

Because the toner located between the electrodes 21a and 21b has a specific polarity, the toner is moved to the adjacent electrode on the surface of the substrate by the electric field directed in the substantially lateral direction. On the other hand, most of the toner located on the electrode hop from the surface of the substrate because the toner is moved at an initial velocity with at least a perpendicular component.

Especially, because the toner located near the edge of the electrode is moved over the adjacent electrode, if the width L is large, an amount of the toner located on the electrode is increased and therefore an amount of the toner moved over a long distance is increased. However, if the width L is too large, intensity of the electric field near the middle of the electrode is decreased. Therefore, the toner adheres to the electrode and the hopping efficiency of the toner is reduced. The inventor(s) has found out an appropriate width of the electrode to cause the toner to hop in an effective manner with a low voltage as a result of intensive researches.

The interval R determines the intensity of the electric field formed between the electrodes 21a and 21b based on a relation between a distance and an applied voltage, and the smaller interval R causes higher intensity of the electric field whereby the initial velocity for the hopping of the toner can be easily obtained. However, if the toner is moved form one electrode to the other electrode, a distance the toner is moved for one time becomes short. Therefore, unless a drive frequency is increased, a time during which the toner is hopping becomes shorter and the toner remains on the surface of the electrode for a longer time. The inventor(s) also has found out an appropriate interval between the electrodes 21a and 21b to cause the toner to be moved by hopping in an effective manner with a low voltage as a result of intensive researches.

Furthermore, it has been found out that the thickness of the surface protecting layer 2b covering the surface of the electrodes 21a and 21b has an influence on the intensity of the electric field generated on the surface of the electrodes 21a and 21b, and especially it has a large influence on a line of electric force with the perpendicular component, which determines the hopping efficiency.

Specifically, if a relation among the width L, the interval R, and the thickness of the surface protecting layer 2b is properly set, it is possible to cause the toner to hop in an effective manner with a low voltage.

In the first embodiment, the width L is set in the range of 1 to 20 times an average particle diameter of the toner, and the interval R is also set in the range of 1 to 20 times an average particle diameter of the toner.

The surface protecting layer 2b can be made of SiO₂, BaTiO₃, TiO₂, TiO₄, SiON, BN, TiN, Ta₂O₅, or the like. The surface protecting layer 2b has a thickness of 0.5 μm to 10 μm, preferably 0.5 μm to 3 μm.

An organic material such as polycarbonate can be coated on SiO₂, or the like. Zirconia or material such as silicone resin generally used as a coating material for a carrier contained in a two-component developer can be selected. Material for the surface protecting layer 2b is selected as appropriate based on a relation among insulation property, durability, a method of manufacturing the flare roller 2, and triboelectric series with the toner to be used.

If the developing device 1 is used in an image forming apparatus, the flare roller 2 needs to have a fine pattern for actual use on a large area of at least A4 size, i.e., more than 21 centimeters (cm) long and more than 30 cm wide.

There are some methods for manufacturing the flare roller 2. One of them is that an electrode pattern is formed on a flexible member and the flexible member is then wound around a roller serving as a support substrate whereby a flare roller is formed.

As an example of a substrate having a flexible fine-pitch film electrode, a base film (having a thickness of 20 μm to 100 μm) made of polyimide is used as a base material (the support substrate 2a), and a film of material such as Cu, Al, or Ni—Cr is formed in a thickness of 0.1 μm to 0.3 μm on the base film by an evaporation method. If the flare roller 2 has the width of 30 cm to 60 cm, it can be manufactured by an apparatus employing a roll-to-roll system, resulting in improved mass productivity. Electrodes having a width of about 1 millimeters (mm) to about 5 mm are concurrently formed by a common bus line.

A specific evaporation method can be a sputtering method, an ion plating method, a chemical vapor deposition (CVD) method, an ion beam method, or the like. For example, if an electrode is formed by the sputtering method, a Cr film can be interposed to improve adhesiveness with polyimide. Moreover, the adhesiveness can be improved by plasma processing or primer processing.

The film electrode can be formed by an electrodeposition method instead of the evaporation method. In such a case, an electrode is first formed on the base material of polyimide by electroless plating. After a base electrode is formed by sequentially immersing the base material in SnCl₂, PdCl₂, and NiCl₂, electrolytic plating is performed on the base electrode in a Ni electrolyte solution whereby a Ni film having a thickness of 1 μm to 3 μm can be formed in roll-to-roll.

The film electrode is subjected to photoresist application, patterning, and etching whereby the electrodes 21a and 21b are formed. In this case, if the film electrode has a thickness of 0.1 μm to 3 μm, it is possible to form a fine-pattern electrode having a width or an interval of five μm to several tens of μm by photolithography or etching with high accuracy.

A film of material such as SiO₂, BaTiO₃, or TiO₂ is formed as the surface protecting layer 2b in a thickness of 0.5 μm to 2 μm by sputtering or the like. Alternatively, polyimide is applied as the surface protecting layer 2b in a thickness of 2 μm to 5 μm by a roll coater or a different coating device and is subjected to baking. If any trouble occurs because polyimide is not coated with any material, an inorganic film of SiO₂ or the like can be formed on a surface of the surface protecting layer 2b in a thickness of 0.1 μm to 0.5 μm by sputtering. Furthermore, an organic material such as polycarbonate can be coated on SiO₂ or the like. Zirconia or material such as silicone resin generally used as a coating material for a carrier contained in a two-component developer can be selected.

Because the flexible substrate having the above configuration is formed, it is possible to attach the flexible substrate to a roller or a drum having a cylindrical form, or to form a part of the flexible substrate into a curved shape in an easy manner.

In another example, it is possible to use Cu, SUS, or the like, in a thickness of 10 μm to 20 μm as an electrode material to be formed on the base film (having a thickness of 20 μm to 100 μm) of polyimide as the base material (the support substrate 2a). In such a case, polyimide is applied to a metallic material in a thickness of 20 μm to 100 μm by the roll coater and is subjected to baking. Afterward, patterning is performed on the metallic material by photolithography or etching whereby patterns of the electrodes 21a and 21b are formed, and the electrodes 21a and 21b are coated with polyimide as the surface protecting layer 2b. If the substrate has irregularities corresponding to the electrode made of the metallic material in a thickness of 10 μm to 20 μm, the substrate is planarized and completed.

For example, a polyimide material or a polyurethane material having viscosity of 50 centipoise (cps) to 10,000 cPs, preferably 100 cPs to 300 cPs, is spin-coated and left as it is, so that irregularities on the substrate is smoothed due to surface tension of the material and the surface of a conveying member is planarized.

In another example in which the strength of the flexible substrate is increased, material such as SUS or Al is used in a thickness of 20 μm to 30 μm as a base material, and a diluted polyimide material is coated in the thickness of about 5 μm as an insulating layer (insulation between the electrode and the base material) on the surface of the base material by the roll coater. For example, the polyimide material is subjected to pre-baking for half an hour at 150 degrees Celsius and post-baking for an hour at 350 degrees Celsius, so that a thin polyimide film is formed as the support substrate 2a.

After the plasma processing or the primer processing is performed to improve the adhesiveness, Ni—Cr is evaporated in a thickness of 0.1 μm to 0.2 μm as a thin electrode layer, and the fine-pattern electrodes 21a and 21b are formed in the thickness of several tens of μm by photolithography or etching. Furthermore, the surface protecting layer 2b of SiO₂, BaTiO₃, TiO₂, or the like, is formed in a thickness of about 0.5 μm to about 1 μm on the surface of the electrodes 21a and 21b by sputtering, so that a flexible conveying member can be obtained. Moreover, an organic material such as polycarbonate can be coated on SiO₂, or the like. Zirconia or material such as silicone resin generally used as a coating material for a carrier contained in a two-component developer can be selected.

The flare roller 2 can be manufactured by other methods, for example, screen printing using a conductive ink, inkjet printing, or a method of removing a non-electrode area from an electrode on which plate processing has been performed by laser processing. Thus, methods of forming the electrode pattern and the surface protecting layer 2b are not limited to those described above.

The toner contained in a toner container is conveyed to the supplying and removing roller 3 by the stirring paddle 4. In the configuration of the developing device 1, the supplying and removing roller 3 is rotated in the counter direction with respect to the flare roller 2, so that the supplying and removing roller 3 functions as a removing roller. Alternatively, a supplying member and a removing member can be separately arranged.

When the toner is supplied from the supplying and removing roller 3 to the flare roller 2, the toner is charged due to friction between the flare roller 2 and the supplying and removing roller 3. The charged toner is moved by hopping due to the electric field that is periodically changed between the electrodes 21a and 21b. After the toner is passed by the layer-thickness adjusting member 6 with the rotation of the flare roller 2 whereby an amount of the toner on the surface of the flare roller 2 is adjusted, the toner is conveyed to an area where the flare roller 2 is opposed to the image carrier 9. Then, an electrostatic latent image formed on the surface of the image carrier 9 is developed with the toner while the flare roller 2 and the image carrier 9 are not in contact with each other. On the other hand, the toner that has not been transferred onto the image carrier 9 is passed through the development area and the toner-leakage preventing member 7, removed by the supplying and removing roller 3, and returned to the toner container. Because the toner is hopping on the flare roller 2, adhesion between the toner and the flare roller 2 is small, and therefore the toner is easily removed from the flare roller 2 by the supplying and removing roller 3. The above process is repeated so that the toner is always hopping on the flare roller 2.

The hopping state of the toner is determined based on the adhesion between the toner and the surface of the flare roller 2, and if a charge quantity of the toner is not appropriate, a part of the toner sometimes remains on the surface of the flare roller 2 without hopping.

Therefore, the toner-cloud facilitating member 5 is mounted between a toner supply area and the layer-thickness adjusting member 6 arranged downstream of the toner supply area in the rotation direction of the flare roller 2.

FIG. 7 is a graph for explaining difference in effects with and without the toner-cloud facilitating member 5. The horizontal axis indicates a charge quantity of toner and the vertical axis indicates an amount of toner.

A plate-shaped electrode is used as the toner-cloud facilitating member 5. As described later, alternating-current (AC) bias is applied to the toner-cloud facilitating member 5.

Force for removing the toner from the flare roller 2 and force for pushing the toner back toward the flare roller 2 are alternately exerted at an area where the toner-cloud facilitating member 5 is opposed to the flare roller 2.

Because the force for removing the toner from the flare roller 2 is larger at an area where the toner-cloud facilitating member 5 is arranged than an area where the toner-cloud facilitating member 5 is not arranged, the toner can hop from the flare roller 2 toward the toner-cloud facilitating member 5 even though the toner cannot hop by the electric field generated between the electrodes 21a and 21b. The toner removed from the flare roller 2 starts to hop by the electric field generated between the flare roller 2 and the toner-cloud facilitating member 5 as well as the electric field generated between the electrodes 21a and 21b, so that the number of times that the toner is brought into contact with the surface of the flare roller 2 is increased. Thus, a charge quantity of the toner becomes appropriate due to friction between the toner and the surface of the flare roller 2, and as shown in FIG. 7, variation in distribution of the charge quantity is reduced with the toner-cloud facilitating member 5 than without the toner-cloud facilitating member 5. If the stable charge quantity is obtained, a proper hopping state of the toner can be maintained after the toner is passed through an area where the flare roller 2 is opposed to the toner-cloud facilitating member 5, and after the toner is passed by the layer-thickness adjusting member 6, the toner can be conveyed to the development area to be used for development.

In the first embodiment, square waves shown in FIG. 6B are used as bias to be applied to the electrodes 21a and 21b. Specifically, the square wave bias applied to the electrodes 21a and 21b has the offset voltage V0 of −300 volts (V), the frequency f of 1 kilohertz (kHz), and the peak-to-peak voltage Vpp of 500 V.

Moreover, the plate-shaped electrode having the width of 2 mm is arranged as the toner-cloud facilitating member 5 with a gap of 50 μm interposed at an area where the toner-cloud facilitating member 5 is located closest to the flare roller 2. Square wave bias applied to the toner-cloud facilitating member 5 has the frequency of 2 kHz, the offset voltage of −300 V, and the peak-to-peak voltage Vpp of 600 V. The offset voltage applied to the toner-cloud facilitating member 5 corresponds to an average value of the bias applied to the electrodes 21a and 21b, so that it is possible to prevent the toner-cloud facilitating member 5 from being contaminated with the toner, thereby improving persistence of an effect of toner cloud facilitation. Furthermore, the frequency of the bias applied to the toner-cloud facilitating member 5 is higher than that of the bias applied to the electrodes 21a and 21b, so that frequency of the hopping of the toner can be increased, the hopping of the toner can be effectively facilitated, and the toner cloud can be obtained in an improved manner without adherence of the toner to the flare roller 2.

When an image forming process was performed under the above conditions, an image was formed with a stable density in an improved manner.

Because a duty ratio of the square wave bias applied to the flare roller 2 is 50%, an average value Vave of the bias applied to the flare roller 2 corresponds to the offset voltage V0 of the square wave bias. However, if the average value Vave of the bias applied to the flare roller 2 does not correspond to the offset voltage V0 because, for example, the duty ratio is not 50%, the offset voltage of the bias applied to the toner-cloud facilitating member 5 can be the average value Vave of the bias applied to the flare roller 2.

FIG. 8 is a schematic diagram of a developing device 10 including a wire electrode 15 as a toner-cloud facilitating member according to modification.

In a second embodiment of the present invention, a conductive wire having a diameter of 60 μm is arranged as the wire electrode 15 such that the wire electrode 15 extends in a longitudinal direction with a gap of 50 μm interposed at an area where the wire electrode 15 is located closest to the flare roller 2. Square wave bias applied to the wire electrode 15 has the frequency of 2 kHz, the offset voltage of −300 V, and the peak-to-peak voltage Vpp of 600 V. A condition of the bias applied to the flare roller 2 is the same as that in the first embodiment. Because the thin wire is used as the electrode, a flow current near the surface of the flare roller 2 is not disturbed, and the electrode is not easily contaminated with the toner.

When an image forming process was performed under the above conditions, an image was formed with a stable density in an improved manner.

In a third embodiment of the present invention, direct current (DC) bias is applied to the wire electrode 15. Specifically, the DC bias of +300 V is applied to the wire electrode 15, and the average value Vave of the bias applied to the electrodes 21a and 21b is set to −300 V, so that a potential difference between the wire electrode 15 and the electrodes 21a and 21b is set to 600 V. Under this condition, when the toner is conveyed by the flare roller 2 to an area where the wire electrode 15 is opposed to the flare roller 2, the toner is attracted toward the wire electrode 15 by increasing force, so that the toner adhering to the flare roller 2 is removed from the surface of the flare roller 2 and is caused to hop toward the wire electrode 15. The toner removed from the surface of the flare roller 2 starts to hop by the electric field generated between the electrodes 21a and 21b whereby the number of times that the toner is brought into contact with the surface of the flare roller 2 is increased. Thus, a charge quantity of the toner becomes appropriate due to friction between the toner and the surface of the flare roller 2. If the stable charge quantity is obtained, a proper hopping state of the toner can be maintained after the toner is passed through an area where the flare roller 2 is opposed to the wire electrode 15, and after the toner is passed by the layer-thickness adjusting member 6, the toner can be conveyed to the development area to be used for development.

In another embodiment, a cleaning unit that cleans the wire electrode 15 is arranged, so that the wire electrode 15 is prevented from being contaminated with the toner for a long period and an effect of the toner cloud facilitation can be maintained. A unit that generates an electric field between the wire electrode 15 and the flare roller 2 is arranged as the cleaning unit, and the toner adhering to a conductive member is caused to hop toward the flare roller 2 at appropriate timing, so that the toner can be removed from the conductive member.

According to an aspect of the present invention, it is possible to form an image with a stable density in an improved manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A developing device including a toner carrying member that includes a plurality of electrodes arranged at predetermined intervals in a first direction intersecting with a second direction in which a surface of the toner carrying member moves, a toner supplying member that supplies toner to the toner carrying member, a voltage applying unit that applies a bias to the electrodes in a time-varying manner such that a direction of an electric field is changed temporally in an alternate manner between adjacent electrodes so that the toner carried on the toner carrying member is caused to hop to form a toner cloud, an adjusting member that adjusts an amount of the toner carried on the toner carrying member, the developing device comprising:
a toner-cloud facilitating member that includes a conductive member arranged between the toner supplying member and the adjusting member in the second direction in opposite to the toner carrying member.

2. The developing device according to claim 1, wherein the toner-cloud facilitating member applies a time-varying bias to the conductive member with an average value of the time-varying bias substantially equal to an average value of the bias applied to the electrodes.

3. The developing device according to claim 2, wherein a frequency of the time-varying bias applied to the conductive member is higher than a frequency of the bias applied to the electrodes.

4. The developing device according to claim 2, wherein the conductive member is a plate electrode that is arranged in opposite to a surface of the toner carrying member with a predetermined gap.

5. The developing device according to claim 2, wherein the conductive member is a wire that is arranged in along a longitudinal direction of the toner carrying member with a predetermined gap.

6. The developing device according to claim 2, further comprising a cleaning unit that cleans the toner attached to the conductive member.

7. An image forming apparatus employing an electrophotographic system including a latent image forming unit, a developing unit, a transfer unit, and a fixing unit, wherein
the developing unit is a developing device according to claim 1.

8. An image forming apparatus employing an electrophotographic system that superposing a plurality of images of different colors on an image carrier, the image forming apparatus including a latent image forming unit, a developing unit, a transfer unit, and a fixing unit, wherein
the developing unit is a developing device according to claim 1.

9. A process cartridge used in an electrophotographic system, the process cartridge including a developing unit and at least one of a latent image carrier, a charging unit, and a cleaning unit in an integrated manner, wherein
the developing unit includes
a toner carrying member that includes a plurality of electrodes arranged at predetermined intervals in a first direction intersecting with a second direction in which a surface of the toner carrying member moves,
a toner supplying member that supplies toner to the toner carrying member,
a voltage applying unit that applies a bias to the electrodes in a time-varying manner such that a direction of an electric field is changed temporally in an alternate manner between adjacent electrodes so that the toner carried on the toner carrying member is caused to hop to form a toner cloud,
an adjusting member that adjusts an amount of the toner carried on the toner carrying member, and
a toner-cloud facilitating member that includes a conductive member arranged between the toner supplying member and the adjusting member in the second direction in opposite to the toner carrying member.

10. An image forming apparatus including at least one process cartridge according to claim 9.
